(19) United States
(12) Patent Application Publication
(10) Pub. No.: US 2024/0190156 A1
(43) Pub. Date: Jun. 13, 2024

(54) THERMOSENSITIVE RECORDING MEDIUM

(71) Applicant: Nippon Paper Industries Co., Ltd., Tokyo (JP)

(72) Inventors: Kenji HIRAI, Tokyo (JP); Masaya TOSAKA, Tokyo (JP); Yuuki INAMURA, Tokyo (JP); Yoshimi MIDORIKAWA, Tokyo (JP)

(21) Appl. No.: 18/283,548

(22) PCT Filed: Mar. 10, 2022
(86) PCT No.: PCT/JP2022/010531

§ 371 Date: Sep. 22, 2023

(30) Foreign Application Priority Data
Mar. 29, 2021 (JP) 2021-054732

(51) Int. Cl. B41M 5/327; B41M 5/333; B41M 5/44

(52) U.S. Cl. CPC B41M 5/3275; B41M 5/3335; B41M 5/44

(57) ABSTRACT

A thermosensitive recording medium comprising an undercoat layer provided on a substrate, and a thermosensitive recording layer containing a colorless or pale colored electron donating leuco dye and an electron accepting color developing agent provided on the undercoat layer, wherein the thermosensitive recording layer contains as the electron accepting color developing agent a urea compound represented by the following general formula (Formula 1)

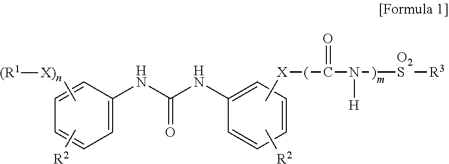

(wherein X represents —O— or —NH—, R¹ represents a hydrogen atom or —SO₂—R³, R³ represents a substituted or unsubstituted alkyl group, aralkyl group or aryl group, R² represents a hydrogen atom or an alkyl group, m represents an integer of 0 to 2, and n represents 0 or 1), and wherein the undercoat layer contains 50 to 95 weight % of a pigment by solid and 50 weight % or more of plastic hollow particles by solid with respect to the pigment.

### CROSS REFERENCE TO RELATED APPLICATIONS

This application is a 371 U.S. National Phase of International Application No. PCT/JP2022/010531, filed on Mar. 10, 2022, which claims priority to Japanese Patent Application No. 2021-054732, filed Mar. 29, 2021. The entire disclosures of the above applications are incorporated herein by reference.

### TECHNICAL FIELD

The present invention relates to a thermosensitive recording medium for recording image by utilizing a coloring reaction between a colorless or pale colored electron donating leuco dye (referred to as “leuco dye”) and an electron accepting color developing agent (referred to as “color developing agent”), which has an excellent high-speed thermal printing ability, as well as excellent oil resistance, plasticizer resistance, printing thermal run-ability, and the like.

### BACKGROUND ART

Thermosensitive recording media are ordinarily prepared by applying the coating solution containing the leuco dye and the color developing agent onto a substrate such as paper, synthetic paper, film, plastic and the like. Thermosensitive recording medium develops color through an instantaneous chemical reaction when heated by a thermal head, hot stamp, hot pen, laser light or the like to yield a recorded image. Such thermosensitive recording media are used extensively in recording media such as facsimile devices, computer terminal printers, automatic ticket dispensers, recorders for meters, receipts at super markets and convenience stores and the like.

In recent years, the use of the thermosensitive recording medium is expanding, such as various ticket, receipts, labels, ATM of Bank, meter reading of gas and electricity, cash vouchers, such as car racing or horseracing betting. Therefore, the thermal recording medium is required to have various performances such as water resistance, plasticizer resistance in the image part, heat resistance of blank part, oil resistance, preservation of image and blank parts under harsh conditions, and the like.

In response to such demands, a thermosensitive recording medium in which water resistance, plasticizer resistance of the image part, heat resistance of blank part, etc. are improved by using a combination of two specific types of color color developing agents (Japanese Patent Application Laid-Open (kokai) No. 2015-80852), and a thermosensitive recording medium in which color density, brightness, and storage stability of printed part etc. are improved by using a urea compound as a color developing agent (International Publication WO2019/044462, Japanese Patent Application Laid-Open (kokai) No. 2020-066148) have been disclosed.

In addition, it is generally known to provide a protective layer on a thermosensitive recording layer to improve storage stability of a thermosensitive recording medium.

It is known to improve the head wearing resistance during thermal printing, the storage stability of printed image and the water resistance of the thermosensitive recording medium by having the thermosensitive recording layer or the protective layer contain a silane modified acrylic resin (Japanese Patent Application Laid-Open (kokai) No. 2020-152027, Japanese Patent No. 6782511 etc.).

Furthermore, it is known that the thermosensitive recording medium shows a sufficient water resistance and the like by having the protective layer contain an acrylic resin with a glass transition temperature (Tg) of higher than 50 degree C. and lower than or equal to 95 degree C.

Furthermore, as a method of improving a sensitivity and a print quality of the thermosensitive recording medium, it has been suggested that an undercoat layer including hollow particles is provided between the substrate and the thermosensitive recording layer (Japanese Patent Application Laid-Open (kokai) No. 2020-152027, Japanese Patent No. 6782511, etc.).

Therefore, the object of the present invention is to provide a thermosensitive recording medium having an excellent high speed thermal printing ability, as well as excellent oil resistance, plasticizer resistance, thermal printing run ability, and the like, among various performances required for the thermosensitive recording medium.

### SUMMARY

As a result of intensive studies, the present inventors have found that the above problems can be solved by having a thermosensitive recording layer provided on a substrate contain a specific urea compound as a color developing agent, providing an undercoat layer between the substrate and the thermosensitive recording layer, and having the undercoat layer contain a specific amount of plastic hollow particles, and then completed the present invention.

The present invention provides a thermosensitive recording medium comprising an undercoat layer provided on a substrate, and a thermosensitive recording layer containing a colorless or pale colored electron donating leuco dye and an electron accepting color developing agent provided on the undercoat layer, wherein the thermosensitive recording layer contains as the electron accepting color developing agent a urea compound represented by the following general formula (Formula 1), and wherein the undercoat layer contains 50 to 95 weight % of a pigment by solid and 50 weight % or more of plastic hollow particles by solid with respect to the pigment.

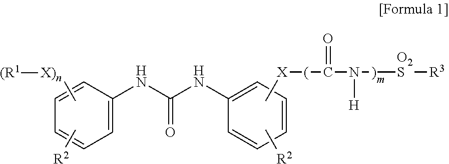

(wherein X represents —O— or —NH—, R¹ represents a hydrogen atom or —SO₂—R³, R³ represents a substituted or unsubstituted alkyl group, aralkyl group or aryl group, R² represents a hydrogen atom or an alkyl group, m represents an integer of 0 to 2, and n represents 0 or 1)

### ADVANTAGEOUS EFFECTS OF THE INVENTION

According to the present invention, it is possible to provide a thermosensitive recording medium having an excellent high speed thermal printing ability while having color developing performance, as well as excellent oil resistance, plasticizer resistance, thermal printing run ability, and the like.

### DETAILED DESCRIPTION

A thermosensitive recording medium of the present invention includes a thermosensitive recording layer provided on a substrate, and an undercoat layer between the substrate and the thermosensitive recording layer; wherein the thermosensitive recording layer contains a specific urea compound as a color developing agent, and wherein the undercoat layer contains a specific amount of plastic hollow particles.

Hereinafter, various materials used in the thermosensitive recording layer of the thermosensitive recording medium of the present invention will be illustrated, however, binders, cross-linking agents, pigments and the like can also be used for other coating layers within the range that does not impair the desired advantages on the above-mentioned problems.

In the thermosensitive recording medium of the present invention, the thermosensitive recording layer contains at least one kind of a urea compound represented by the general formula (Formula 1) as the color developing agent. In the general formula (Formula 1), R³ is preferably a substituted or unsubstituted aryl group, more preferably a group represented by the following formula:

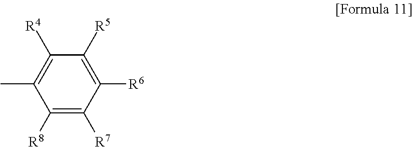

(wherein R⁴ to R⁸ may be identical or different from each other, represent a hydrogen atom, a halogen atom, a nitro group, an amino group, an alkyl group, an alkoxy group, an aryloxy group, an alkylcarbonyloxy group, an arylcarbonyloxy group, an alkylcarbonylamino group, an arylcarbonylamino group, an alkylsulfonylamino group, an arylsulfonylamino group, a monoalkylamino group, a dialkylamino group, or an arylamino group).

The urea compound is preferably selected from the following general formulae (1) to (3).

### (1) A First Urea Compound Represented by the Following General Formula (Formula 2)

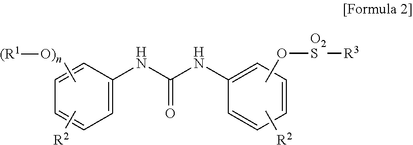

(wherein R¹, R², and R³ are defined as above).

### (2) A Second Urea Compound Represented by the Following General Formula (Formula 3)

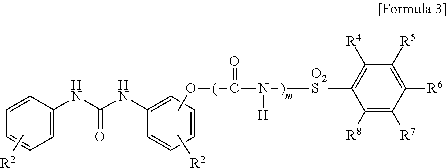

(wherein R² and m are defined as above, and R⁴ to R⁸ are described later).

### (3) A Third Urea Compound Represented by the Following General Formula (Formula 4)

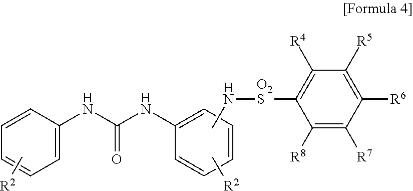

(wherein R² and m are defined as above, and R⁴ to R⁸ are described later).

Furthermore, the urea compound used in the present invention preferably includes at least two kinds of the urea compounds selected from the above-described general formulae (1) to (3). However, in this case, the urea compound is not selected from two or more kinds of each of (1), (2) or (3). That is, the urea compound including at least two kinds is a combination of the first urea compound and the second urea compound, a combination of the first urea compound and the third urea compound, a combination of the second urea compound and the third urea compound, or a combination of the first to third urea compounds represented by (1) to (3).

The first urea compound used in the present invention is represented by the following formula (Formula 2) and is preferably represented by the following formula (Formula 5).

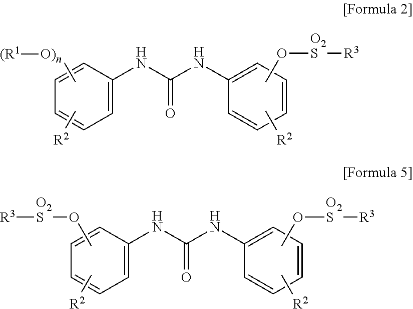

In the general formula (Formula 2), R¹ represents a hydrogen atom or —SO₂—R³, and n represents 0 or 1, preferably 1.

In the above general formula (Formula 2) and general formula (Formula 5), R² represents an alkyl group, an aralkyl group or an aryl group, all of which may be substituted or unsubstituted. The alkyl group is, for example, a linear, branched or alicyclic alkyl group, preferably having 1 to 12 carbon atoms. The carbon number of the aralkyl group is preferably 7 to 12, and the carbon number of the aryl group is preferably 6 to 12. When these are substituted, the substituent is preferably an alkyl group having 1 to 12 carbon atoms, an alkoxy group having 1 to 12 carbon atoms, an aryl group having 6 to 12 carbon atoms or a halogen atom. Further, the plurality of R² may be the same or different.

The position of R¹—O— in the benzene ring in the general formula (Formula 2) may be the same or different, and is preferably the 3-position, 4-position or 5-position.

The position of R¹—SO₂—O— in the benzene ring in the general formula (Formula 2) and general formula (Formula 5) may be the same or different, and is preferably the 3-position, 4-position or 5-position.

The alkyl group includes methyl group, ethyl group, n-propyl group, iso propyl group, n-butyl group, iso butyl group, t-butyl group, cyclopentyl group, hexyl group, cyclohexyl group, 2-ethylhexyl group, a lauryl group and the like.

The aralkyl group may be an unsubstituted aralkyl group or an aralkyl group substituted by alkyl group, alkoxy group, aralkyl group, aryl group or halogen atom. Examples thereof include benzyl group, 1-phenylethyl group, 2-phenylethyl group, 3-phenylpropyl group, p-methylbenzyl group, m-methylbenzyl group, m-ethylbenzyl group, p-ethylbenzyl group, p-iso propylbenzyl group, p-t-butylbenzyl group, p-methoxybenzyl group, m-methoxybenzyl group, o-methoxybenzyl group, m, p-di-methoxybenzyl group, p-ethoxy-m-methoxybenzyl group, p-phenylmethoxybenzyl group, p-cumylbenzyl group, p-phenylbenzyl group, o-phenylbenzyl group, m-phenylbenzyl group, p-tolylbenzyl group, m-tolylbenzyl group, o-tolylbenzyl group and a p-chlorobenzyl group, and the like.

The aryl group may be an unsubstituted aryl group or an aryl group substituted by alkyl group, alkoxy group, aralkyl group, aryl group or halogen atom. Examples thereof include phenyl group, p-tolyl group, m-tolyl group, o-tolyl group, 2,5-dimethylphenyl group, 2,4-dimethylphenyl group, 3,5-dimethylphenyl group, 2,3-dimethylphenyl group, 3,4-dimethylphenyl group, mesitylene group, p-methoxyphenyl group, p-iso propylphenyl group, p-t-butylphenyl group, p-methoxyphenyl group, 3,4-dimethoxyphenyl group, p-ethoxyphenyl group, p-chlorophenyl group, 1-naphthyl group, 2-naphthyl group, t-butylated naphthyl group, and the like.

R² represents a hydrogen atom or an alkyl group, preferably a hydrogen atom. The alkyl group is preferably an alkyl group having 1 to 4 carbon atoms, which is, for example, methyl group, ethyl group, propyl group, isopropyl group, butyl group, isobutyl group, sec butyl group, t-butyl group and the like.

The position of R² in the benzene ring in the general formula (Formula 2) may be the same or different, and is preferably 3-position, 4-position, or 5-position.

The first urea compound of the present invention is more preferably the first urea compound represented by the following general formula (Formula 6).

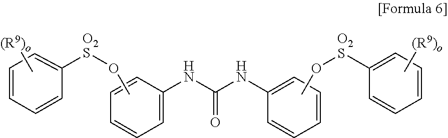

In the general formula (Formula 6), R⁹ is alkyl group or alkoxy group, preferably alkyl group. n represents an integer of 0 to 3, preferably 0 to 2, and more preferably 0 to 1. The number of carbon atoms of the alkyl group is, for example, 1 to 12, preferably 1 to 8, and more preferably 1 to 4.

The position of R⁹ in the benzene ring in the general formula (Formula 6) may be the same or different, and is preferably 3-position, 4-position or 5-position, more preferably 4-position.

Further, the examples of the first urea compound used in the present invention includes, N,N′-di-[3-(benzenesulfonyloxy) phenyl] urea, N N′-di-[3-(benzenesulfonyloxy)-4-methyl-phenyl] urea, N,N′-di-[3-(benzenesulfonyloxy) -4-ethyl-phenyl] urea, N,N′-di-[3-(benzenesulfonyloxy)-5-methyl-phenyl] urea, N, N′-di-[3-(benzenesulfonyloxy)-4-propyl-phenyl] urea, N,N′-di-[3-(o-toluenesulfonyloxy) phenyl] urea, N,N′-di-[3-(m-toluenesulfonyloxy) phenyl] urea, N,N′-di-[3-(p-toluenesulfonyloxy) phenyl] urea, N,N′di-[3-(p-toluenesulfonyloxy)-4-methyl-phenyl] urea, N,N′-di-[3-(p-xylenesulfonyloxy) phenyl] urea, N,N′-di-[3-(m-xylenesulfonyloxy) phenyl] urea, N,N′-di-[3-(mesitylene sulfonyloxy) phenyl] urea, N,N′-di-[3-(1-naphthalenesulfonyloxy) phenyl] urea, N,N′-di-[3-(2-naphthalenesulfonyloxy) phenyl] urea, N,N′-di-[3-(p-ethylbenzenesulfonyloxy) phenyl] urea, N,N′-di-[3-(p-propylbenzenesulfonyloxy) phenyl] urea, N,N′-di-[3-(p-isopropylbenzenesulfonyloxy) phenyl] urea, N,N′-di-[3-(pt-butylbenzenesulfonyloxy) phenyl] urea, N,N′-di-[3-(p-methoxybenzenesulfonyloxy) phenyl] urea, N,N′-di-[3-(m-methoxybenzenesulfonyloxy) phenyl] urea, N,N′-di-[3-(o-methoxybenzenesulfonyloxy) phenyl] urea, N,N′-di-[3-(m, p-dimethoxybenzenesulfonyloxy) phenyl] urea, N,N′-di-[3-(p-ethoxybenzenesulfonyloxy) phenyl] urea, N,N′-di-[3-(p-propoxybenzenesulfonyloxy) phenyl] urea, N,N′-di-[3-(p-butoxybenzenesulfonyloxy) phenyl] urea, N,N′-di-[3-(p-cumylbenzylsulfonyloxy) phenyl] urea, N,N′-di-[3-(p-cumylbenzenesulfonyloxy) phenyl] urea, N,N′-di-[3-(o-phenylbenzenesulfonyloxy) phenyl] urea, N,N′-di-[3-(p-phenylbenzenesulfonyloxy) phenyl] urea, N,N′-di-[3-(p-chlorobenzenesulfonyloxy) phenyl] urea, N,N′-di-[4-(benzenesulfonyloxy) phenyl] urea, N,N′-di-[4-(p-toluenesulfonyloxy) phenyl] urea, N,N′-di-[3(ethanesulfonyloxy) phenyl] urea, N,N′-di-[3-(benzylsulfonyloxy) phenyl] urea, and the like. However, the first urea compound of the present invention is not limited to these.

The second urea compound used in the present invention is represented by the general formula (Formula 3).

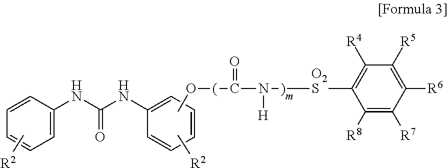

In the general formula (Formula 3), R², R⁴ to R⁸ are defined as above. In the general formula (Formula 3), R⁴ to R⁸ are preferably a hydrogen atom, an alkyl group or an alkyl group. In particular, R⁴, R⁵, R⁷ or R⁸ preferably represent a hydrogen atom, and R⁶ preferably represent a hydrogen atom or an alkyl group, and R⁶ particularly preferably is an alkyl group.

The alkyl group (including the alkyl group in the alkylcarbonyloxy group, the alkylcarbonylamino group, the alkylsulfonylamino group, the monoalkylamino group, and the dialkylamino group) and the aryl group (including the aryl group in the aryloxy group, the arylcarbonyloxy group, the arylcarbonylamino group, the arylsulfonylamino group, and the arylamino group) are defined in the same manner as in the alkyl group and the aryl group in the above general formula (Formula 2).

The alkoxy group may be, for example, a linear, branched or alicyclic alkoxy group, and the number of carbon atoms in the alkoxy group is preferably 1 to 12.

The position of the —O— (CONH) m-SO₂-substituted phenyl group in the benzene ring of the general formula (Formula 3) is preferably at 3-position, 4-position, or 5-position (the same applies to the following general formula (Formula 7) and general formula (Formula 8)).

In the general formula (Formula 3), m represents an integer of 0 to 2, preferably 0 to 1.

The second urea compound of the present invention is preferably a urea compound represented by the following general formula (Formula 7) or general formula (Formula 8).

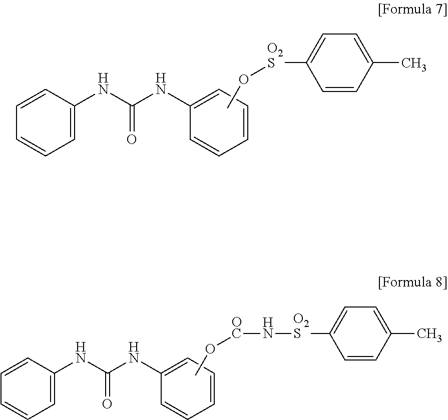

The third urea compound used in the present invention is represented by the general formula (Formula 4).

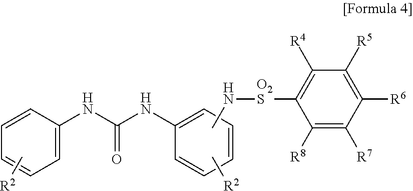

In the general formula (Formula 4), R², R⁴ to R⁸ are defined as above.

The third urea compound is preferably N-[2-(3-phenylureido) phenyl] benzenesulfonamide. The compound is represented by the following formula and is available, for example, under the trade name of NKK 1304 manufactured by Nippon Soda Co., Ltd.

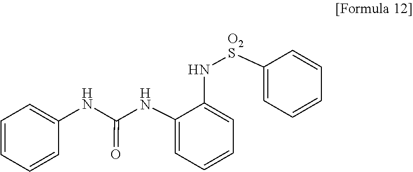 [SMILES: O=C(Nc1ccccc1)Nc1ccccc1NS(=O)(=O)c1ccccc1]

The content (in solid, combined amount when a plurality of urea compounds is contained) of the urea compound in the thermosensitive recording layer of the present invention is from 1.0 to 70.0 weight %, preferably from 5.0 to 65.0 weight %, more preferably 10.0 to 60.0 weight %.

The content of the first urea compound in the thermosensitive recording layer of the present invention is from 1.0 to 50.0 weight %, preferably 5.0 to 40.0 weight %. The content of the second urea compound is from 5.0 to 50.0 weight %, preferably 5.0 to 40.0 weight %. The content of the third urea compound is from 5.0 to 50.0 weight %, preferably 5.0 to 40.0 weight %.

In the case when the thermosensitive recording layer of the present invention contains the first and second urea compounds, the content of the second urea compound in the thermosensitive recording layer is preferably 0.1 to 30.0 weight parts, more preferably 0.5 to 25.0 weight parts, further preferably 1.0 to 20.0 weight parts, especially preferably 2.0 to 15.0 weight parts per 1.0 weight parts of the first urea compound. In addition, in the case when the thermosensitive recording layer of the present invention contains the first and third urea compounds, the content of the third urea compound in the thermosensitive recording layer is preferably 0.1 to 30.0 weight parts, more preferably 0.5 to 25.0 weight parts, further preferably 1.0 to 20.0 weight parts, especially preferably 2.0 to 15.0 weight parts per 1.0 weight parts of the first urea compound. In addition, in the case when the thermosensitive recording layer of the present invention contains the second and third urea compounds, the content of the third urea compound in the thermosensitive recording layer is preferably 0.1 to 30.0 weight parts, more preferably 0.3 to 25.0 weight parts, further preferably 0.5 to 20.0 weight parts, especially preferably 0.7 to 15.0 weight parts per 1.0 weight parts of the second urea compound.

The thermosensitive recording layer of the present invention may contain color developing agent(s) other than the first urea compound and the second urea compound. As such color developing agents, for example, activated clay, attapulgite, colloidal silica, inorganic acidic substances such as aluminum silicate and the like, 4,4′-isopropylidene diphenol, 1,1-bis(4-hydroxyphenyl) cyclohexane, 2,2-bis(4-hydroxyphenyl)-4-methylpentane, 4,4′-dihydroxydiphenyl sulfide, hydroquinone monobenzyl ether, benzyl 4-hydroxybenzoate, 4,4′-dihydroxy diphenyl sulfone, 2,4′-dihydroxy diphenyl sulfone, 4-hydroxy-4′-isopropoxy diphenyl sulfone, 4-hydroxy-4′-n-propoxy diphenyl sulfone, bis(3-allyl-4-hydroxyphenyl) sulfone, 4-hydroxy-4′-methyldiphenyl sulfone, 4-hydroxyphenyl-4′-benzyloxy phenyl sulfone, 3,4-dihydroxyphenyl-4′-methyl phenyl sulfone, 1-[4-(4-hydroxyphenyl-sulfonyl) phenoxy]-4-[4-(4-isopropoxyphenyl sulfonyl) phenoxy] butane, phenol condensate composition described in Japanese Patent Application Public Disclosure No. 2003-154760, aminobenzene sulfonamide derivatives described in Japanese Patent Application Public Disclosure No. H08-59603, bis(4-hydroxyphenyl thioethoxy) methane, 1,5-di(4-hydroxyphenyl thio)-3-oxapentane, butyl bis(p-hydroxyphenyl) acetate, methyl bis(p-hydroxyphenyl) acetate, 1,1-bis(4-hydroxyphenyl)-1-phenyl ethane, 1,4-bis[α-methyl-α-(4′-hydroxyphenyl)ethyl] benzene, 1,3-bis[α-methyl-α-(4′-hydroxyphenyl)ethyl] benzene, di(4-hydroxy-3-methylphenyl) sulfide, 2,2′-thiobis(3-tert-octylphenol), 2,2′-thiobis(4-tert-octylphenol), compounds described in International Publication WO02/081229 or Japanese Patent Application Public Disclosure No. 2002-301873, thiourea compounds such as N,N′-di-m-chlorophenyl thiourea and the like, p-chlorobenzoic acid, stearyl gallate, bis[zinc 4-octyloxy carbonylamino salicylate] dihydrate, 4-[2-(p-methoxyphenoxy) ethyloxy] salicylic acid, 4-[3-(p-tolylsulfonyl) propyloxy] salicylic acid, aromatic carboxylic acids such as 5-[p-(2-p-methoxyphenoxyethoxy) cumyl] salicylic acid, and salts of these aromatic carboxylic acids and polyvalent metals such as zinc, magnesium, aluminum, calcium, titanium, manganese, tin, nickel and the like, and, furthermore, antipirin complexes of zinc thiocyanate and complex zinc salts of terephthal aldehyde acid with other aromatic carboxylic acids and the like may be cited. These color developing agents may be used individually or as a mixture of at least two of them.

1-[4-(4-hydroxyphenyl-sulfonyl) phenoxy]-4-[4-(4-isopropoxyphenyl sulfonyl) phenoxy] butane is available, for example, under the trade name of JKY-214 produced by API Corporation. The phenol condensate composition described in Japanese Patent Application Public Disclosure No. 2003-154760 is available, for example, under the trade name of JKY-224 produced by API Corporation. The compound described in International Publication WO02/081229 is available, for example, under the trade names of NKK-395 and D-100 produced by Nippon Soda Co., Ltd. In addition, high molecular weight aliphatic acid metal complex salts described in Japanese Patent Application Public Disclosure No. H10-258577 and metal chelate type color developing components such as polyvalent hydroxy aromatic compounds and the like may also be present.

In the case when the thermosensitive recording layer contains color developing agent other than the first to third urea compound, the combined amount (in solid) of the the first to third urea compound used is preferably 50 weight % or more, more preferably 80 weight % or more, further preferably 90 weight % or more of the total amount of the color developing agents contained in the thermosensitive recording layer, which contains the first to third urea compound.

All of the leuco dyes well known in the conventional field of pressure sensitive and thermosensitive recording media may be used as the electron donating leuco dye in the present invention. Although the leuco dye is not particularly restricted, triphenylmethane type compounds, fluorane type compounds, fluorene type compounds, divinyl type compounds and the like are preferred as the leuco dye. Specific examples of the typical colorless to pale colored basic colorless leuco dye (leuco dye precursors) are shown below. In addition, these leuco dye precursors may be used individually and also in mixtures of at least two of them.

### <Triphenylmethane Type Leuco Dyes>

3,3-bis(p-Dimethyl aminophenyl)-6-dimethylaminophthalide [alternate name: crystal violet lactone] and 3,3-bis(p-Dimethyl aminophenyl) phthalide [alternate name: malachite green lactone]

<Fluorane Type Leuco Dyes>3-Diethylamino-6-methylfluorane, 3-diethylamino-6-methyl-7-anilinofluorane, 3-diethylamino-6-methyl-7-(o,p-dimethylanilino)fluorane, 3-diethylamino-6-methyl-7-chlorofluoran, 3-diethylamino-6-methyl-7-(m-trifluoromethylanilino) fluorane, 3-diethylamino-6-methyl-7-(o-chloroanilino) fluorane, 3-diethylamino-6-methyl-7-(p -chloroanilino) fluorane, 3-diethylamino-6-methyl-7-(o-fluoroanilino) fluorane, 3-diethylamino-6-methyl-7-(m-methylanilino) fluorane, 3-diethylamino-6-methyl-7-n-octylanilino fluorane, 3-diethylamino-6-methyl·7-n-octylamino fluorane, 3-diethylamino-6-methyl-7-benzylamino fluorane, 3-diethylamino-6-methyl-7-dibenzylamino fluorane, 3-diethylamino-6-chloro-7-methyl fluorane, 3-diethylamino-6-chloro-7-anilino fluorane, 3-diethylamino-6-chloro-7-p-methylanilino fluorane, 3-diethylamino-6-ethoxyethyl-7-anilino fluorane, 3-diethylamino-7-methyl fluorane, 3-diethylamino-7-chloro fluorane, 3-diethylamino-7-(m-trifluoromethylanilino) fluorane, 3-diethylamino-7-(o-chloroanilino) fluorane, 3-diethylamino-7-(p-chloroanilino) fluorane, 3-diethylamino-7-(o-fluoroanilino) fluorane, 3-diethylamino-benz[a] fluorane, 3-diethylamino-benz[c] fluorane, 3-dibutylamino-6-methyl-fluorane, 3-dibutylamino-6-methyl-7-anilino fluorane, 3-dibutylamino-6-methyl-7-(o,p-dimethylanilino) fluorane, 3-dibutylamino-7-(o-chloroanilino) fluorane, 3-butylamino-6-methyl-7-(p-chloroanilino) fluorane, 3-dibutylamino-6-methyl-7-(o-fluoroanilino) fluorane, 3-dibutylamino-6-methyl-7-(m-fluoroanilino) fluorane, 3-dibutylamino-6-methyl-chloro fluorane, 3-dibutylamino-6-ethoxyethyl-7-anilino fluorane, 3-dibutylamino-6-chloro-7-anilino fluorane, 3-dibutylamino-6-methyl-7-p-methylanilino fluorane, 3-dibutylamino-7-(o-chloroanilino) fluorane, 3-dibutylamino-7-(o-fluoroanilino) fluorane, 3-di-n-pentylamino-6-methyl-7-anilino fluorane, 3-di-n-pentylamino-6-methyl-7-(p-chloroanilino) fluorane, 3-di-n -pentylamino-7-(m-trifluoromethylanilino) fluorane, 3-di-n-pentylamino-6-chloro-7-anilino fluorane, 3-di-n-pentylamino-7-(p-chloroanilino) fluorane, 3-pyrolidino-6-methyl-7-anilino fluorane, 3-piperidino-6-methyl-7-anilino fluorane, 3-(N-methyl-N-propylamino)-6-methyl-7-anilino fluorane, 3-(N-methyl-N-cyclohexylamino)-6-methyl-7-anilino fluorane, 3-(N-ethyl-N-cyclohexylamino)-6-methyl-7-anilino fluorane, 3-(N-ethyl-N-xylylamino)-6-methyl-7-(p-chloroanilino) fluorane, 3-(N-ethyl-p-toluidino)-6-methyl-7-anilino fluorane, 3-(N-ethyl-N-isoamylamino)-6-methyl-7-anilino fluorane, 3-(N-ethyl-N-isoamylamino)-6-chloro-7-anilino fluorane, 3-(N-ethyl-N-tetrahydrofurfurylamino)-6-methyl-7-anilino fluorane, 3-(N-ethyl-N-isobutylamino)-6-methyl-7-anilino fluorane, 3-(N-ethyl-N -ethoxypropylamino)-6-methyl-7-anilino fluorane, 3-cyclohexylamino-6-chloro fluorane, 2-(4-oxahexyl)-3-dimethylamino-6-methyl-7-anilino fluorane, 2-(4-oxahexyl)-3-diethylamino-6-methyl-7-anilino fluorane, 2-(4-oxahexyl)-3-dipropylamino-6-methyl-7-anilino fluorane, 2-methyl-6-o-(p-dimethylaminophenyl) aminoanilino fluorane, 2-methoxy-6-p-(p-dimethylaminophenyl) aminoanilino fluorane, 2-chloro-3-methyl-6-p-(p-phenylaminophenyl) aminoanilino fluorane, 2-chloro-6-p-(p-dimethylaminophenyl) aminoanilino fluorane, 2-nitro-6-p-(p-diethylaminophenyl) aminoanilino fluorane, 2-amino-6-p-(p-diethylaminophenyl) aminoanilino fluorane, 2-diethylamino-6-p-(p -diethylaminophenyl) aminoanilino fluorane, 2-phenyl-6-methyl-6-p-(p -phenylaminophenyl) aminoanilino fluorane, 2-benzyl-6-p-(p-phenylaminophenyl) aminoanilino fluorane, 2-hydroxy-6-p-(p-phenylaminophenyl)aminoanilino fluorane, 3-methyl-6-p-(p-dimethylaminophenyl) aminoanilino fluorane, 3-diethylamino-6-p-(p-diethylaminophenyl) aminoanilino fluorane, 3-diethylamino-6-p-(p- dibutylaminophenyl) aminoanilino fluorane and 2,4-dimethyl-6-[(4-dimethylamino) anilino] fluorane.

### <Fluorene Type Leuco Dye>

3,6,6-Tris(dimethylamino) spiro[fluorane-9,3′-phthalide] and 3,6,6′-tris (diethylamino) spiro[fluorane-9,3′-phthalide].

### <Divinyl Type Leuco Dyes>

3,3-bis-[2-(p-dimethylaminophenyl)-2-(p-methoxyphenyl) ethenyl]-4,5,6,7-tetrabromophthalide, 3,3-bis-[2-(p-dimethylaminophenyl)-2-(p-methoxyphenyl) ethenyl]-4,5,6,7-tetrachlorophthalide, 3,3-bis-[1,1-bis (4-pyrrolidinophenyl) ethylene-2-yl] 4,5,6,7-tetra bromophthalide, 3,3-bis-[1-(4-methoxyphenyl)-1-(4-pyrrolidinophenyl) ethylene-2-yl] -4,5,6,7·tetrachlorophthalide

### <Others>

3-(4-Diethylamino-2-ethoxyphenyl)-3-(1-ethyl-2-methylindol-3-yl)-4-azapht halide, 3-(4-diethylamino-2-ethoxyphenyl)-3-(1-octyl-2-methylindol-3-yl)-4-azaphthalide, 3-(4-cyclohexyl ethylamino-2-methoxyphenyl)-3-(1-ethyl-2-methylindol-3-yl)-4-azaphthalide, 3,3-bis(1-ethyl-2-methylindol-3-yl)phthalide, 3,6-bis(diethylamino)fluorane-γ-(3′-nitroanilinolactam, 3,6-bis(diethylamino)fluorane-γ-(4′-nitro) anilinolactam, 1,1-bis-[2′,2′,2″,2″-tetrakis-(p-dimethylaminophenyl)-ethenyl]-2,2-dinitrilethane, 1,1-bis-[2′,2′,2″,2″-tetrakis-(p-dimethylaminophenyl)-ethenyl]-2-β-naphthoylethane, 1,1-bis-[2′,2′,2″,2″-tetrakis-(p-dimethylaminophenyl)-ethenyl]-2,2-diacetylethane and bis-[2,2,2′,2′-tetrakis-(p-dimethylaminophenyl)-ethenyl]-methylamlonic acid dimethyl ester.

The previously wellknown sensitizers may be used as the sensitizer in the thermosensitive recording medium of the present invention. As such sensitizers, aliphatic acid amides such as stearic acid amide, palmitic acid amide and the like, ethylene bis-amide, montan acid wax, polyethylene wax, 1,2-di-(3-methylphenoxy) ethane, p-benzyl biphenyl, β-benzyloxy naphthalene, 4-biphenyl-p-tolyl ether, m-terphenyl, 1,2-diphenoxyethane, dibenzyl oxalate, di(p-chlorobenzyl) oxalate, di(p-methylbenzyl) oxalate, dibenzyl terephthalate, benzyl p-benzyloxy benzoate, di-p-tolyl carbonate, phenyl-α-naphthyl carbonate, 1,4-diethoxynaphthalene, 1-hydroxy-2-naphthoic acid phenyl ester, o-xylene-bis-(phenyl ether), 4-(m-methyl phenoxymethyl) biphenyl, 4,4′ethylene dioxy-bis-benzoic acid dibenzyl ester, dibenzoyloxy methane, 1,2-di(3-methylphenoxy) ethylene, bis[2-(4-methoxy-phenoxy) ethyl] ether, methyl p-nitrobenzoate, phenyl p-toluene sulfonate, o-toluenesulfonamide, p-toluenesulfonamide, and the like may be listed as examples. These sensitizers may be used individually and as mixtures of at least two of them.

As a pigment used in the present invention, kaolin, calcined kaolin, calcium carbonate, aluminum oxide, titanium oxide, magnesium carbonate, aluminum silicate, magnesium silicate, calcium silicate, aluminum hydroxide, silica and the like may be used. These pigments may be used in combinations depending on the required quality.

As the binder used in the present invention, completely saponified polyvinyl alcohol, partially saponified polyvinyl alcohol, modified polyvinyl alcohols such as acetoacetylated polyvinyl alcohol, carboxyl modified polyvinyl alcohol, amide modified polyvinyl alcohol, sulfonic acid modified polyvinyl alcohol, butyral modified polyvinyl alcohol, olefin modified polyvinyl alcohol, nitrile modified polyvinyl alcohol, pyrolidone modified polyvinyl alcohol, silicone modified polyvinyl alcohol, other modified polyvinyl alcohol, hydroxyethyl cellulose, methyl cellulose, ethyl cellulose, carboxymethyl cellulose,-styrene maleic anhydride copolymer, styrene butadiene copolymer, cellulose derivatives such as ethyl cellulose and acetyl cellulose, casein, gum Arabic, oxidized starch, etherified starch, dialdehyde starch, esterified starch, polyvinyl chloride, polyvinyl acetate, polyacrylamide, polyacrylic acid ester, polyvinyl butylal, polystyrol and their copolymers, silicone resins, petroleum resins, terpene resins, ketone resins, cumaron resins and the like may be listed as examples. The polymeric substances may be used upon dissolving them in a solvent such as water, alcohol, ketones, esters, hydrocarbons and the like or upon emulsifying or dispersing into a paste in water or other media. These polymeric materials may also be used in combinations according to the qualities demanded.

As the lubricant used in the present invention, fatty acid metal salts such as zinc stearate, calcium stearate, and the like, waxes, silicone resins, and the like may be cited.

Stabilizing agents that improve oil resistance of recorded images and the like, such as 4,4′-butylidene (6-t-butyl-3-methylphenol), 2,2′-di-t-butyl-5,5′-dimethyl-4,4′-sulfonyl diphenol, 1,1,3-tris (2-methyl-4-hydroxy-5-cyclohexylphenyl) butane, 1,1,3-tris (2-methyl-4-hydroxy-5-t-butylphenyl) butane and the like may also be added in the range that does not adversely affect the desired effects for the problems described above.

In addition, a benzophenone type and triazole type UV absorbers, dispersion agent, de-foaming agent, antioxidant, fluorescent dye and the like may also be used.

The types and amounts of the leuco dye, color developing agent, sensitizer and other various ingredients used in the thermosensitive recording medium of the present invention may be determined according to the required performance and printability. Although the amounts of the color developing agent, the sensitizer, the pigment, the stabilizing agent and the other ingredients are not particularly restricted, from 0.5 parts to 10 parts of the color developing agent, from 0.1 parts to 10 parts of the sensitizer, from 0.5 parts to 20 parts of the pigment, from 0.01 parts to 10 parts of the stabilizing agent and from 0.01 parts to 10 parts of the other ingredients are ordinarily used per 1 part of the leuco dye. The content (in solid) of the binders in the thermosensitive recording layer is suitably around from 5 to 25 weight %.

The leuco dye, the color developing agent and the other materials added as needed are finely ground into particles with several microns or smaller in size, by using a grinder or a suitable emulsification device such as a ball mill, attritor, sand grinder and the like. The coating solutions are prepared by adding a binder and various additives to these depending on the objective. Water, alcohol and the like can be used as the solvent for the coating solution and the content (in solid) of the coating solution is about from 20 to 40 weight %.

The thermosensitive recording medium of the present invention includes the undercoat layer between the substrate and the thermosensitive recording layer.

The undercoat layer includes mainly the binder and the pigment.

As the binder used in the undercoat layer, the binder that can be used in the above-described thermosensitive recording layer can be used, as appropriate. The binder may be used individually or as mixtures of two of them.

The pigment used in the undercoat layer contains plastic hollow particles. The plastic hollow particles used in the present invention are minute hollow particles having a thermoplastic resin as shells, containing air or other gases inside, and being already in a foamed state.

Examples of the thermoplastic resin can include polystyrene, polyvinyl chloride, polyvinylidene chloride, polyvinyl acetate, polyacrylic acid ester, polyacrylonitrile, polybutadiene, or their copolymers. In particular, a styrene resin such as polystyrene, an acrylic resin such as polyacrylic acid ester and polyacrylonitrile, their copolymers, or a copolymer resin mainly composed of polyvinylidene chloride and polyacrylonitrile are preferable.

Such organic hollow particles are available as SX8782 manufactured by JSR Corporation, MH5055 and MH8108A manufactured by Zeon Corporation, Low Bake HP-91 manufactured by Rohm and Haas Electronic Materials K.K., microsphere manufactured by Matsumoto Yushi-Seiyaku Co., Ltd.

A volume hollow percentage of the plastic hollow particles used in the present invention is preferably about 40 to 95%. When the volume hollow percentage is 40% or more, thermal insulation can be improved and color developing properties can be further enhanced.

On the other hand, when the percentage is 95% or less, strength of the shells of the hollow particles is enhanced to effectively keep a hollow state and the undercoat layer with good surface strength is easily provided. The volume hollow percentage herein is a value determined by (d3/D3)×100 wherein d represents an inner diameter of the organic hollow particle and D represents an outer diameter of the organic hollow particle.

The undercoat layer may contain a pigment other than the plastic hollow particles, and inorganic pigment such as calcium carbonate, silica, zinc oxide, titanium oxide, aluminum hydroxide, magnesium hydroxide, kaolin, calcined kaolin, clay, and talc, organic pigment such as plastic hollow particles, and the like can be used, for example. The pigment may be used individually or as mixtures of two of them. As the pigment other than the plastic hollow particles, calcined kaolin is preferably used.

The content of the pigment in the undercoat layer is generally 50 to 95 weight %, preferably 70 to 90 weight % with respect to the undercoat layer (in solid). The content of the plastic hollow particles in the undercoat layer is 50 weight % or more, preferably 70 to 100 weight %, more preferably 80 to 100 weight % with respect to the pigment (in solid) in the undercoat layer.

Various aids such as a dispersion agent, plasticizer, pH controlling agent, de-foaming agent, water retention agent, preservative, coloring dye, UV absorber and the like may be added to the undercoat layer, as required.

The thermosensitive recording medium of the present invention may have further a protective layer.

The protective layer is mainly composed of the binder and the pigment, to which a cross-linking agent may be further added.

As the binder, the binder usable in the above-described thermosensitive recording layer can be used, as appropriate, and carboxy-modified polyvinyl alcohol and non-core-shell type acrylic resin having the glass transition point (Tg) of 50 degree C. or more are preferable. The binder may be used individually or as mixtures of two of them.

Crosslinking agent includes, for example, epichlorohydrin resins such as poly(amine epichlorohydrin) resins, poly(amide epichlorohydrin) resins and the like; modified modified polyamine/amide resins such as polyamide urea resins, polyalkylene polyamine resins, polyalkylene polyamide resins, polyamine polyurea resins, modified polyamine resins, modified polyamide resins, polyalkylene polyamine urea formalin resins, polyalkylene polyamine polyamide polyurea resins, and the like; glyoxal, methylol melamine, melamine formaldehyde resin, melamine urea resin, potassium persulfate, ammonium persulfate, sodium persulfate, ferric chloride, magnesium chloride, borax, boric acid, alums (aluminum potassium sulfate), ammonium chloride, and the like. When the protective layer preferably contains epichlorohydrin resin and polyamine/polyamide resin, the water resistance becomes particularly better.

The amount of the binder or the combined amount of the binder and the pigment in the protective layer is, in terms of solid content, usually from 80 to 100 weight %, preferably from 90 to 100 weight %. The amount of the binder is preferably about from 30 to 300 parts by weight per 100 parts by weight of the pigment.

If necessary, the coating solution for the protective layer may further contain cross-linking agents, lubrincants, stabilizers, and various auxiliary agents such as UV absorbing agents, dispersants, defoaming agents, antioxidants, fluorescent dyes, etc. that can be used for the above mentioned thermosensitive recording layer.

In the present invention, the method for coating the thermosensitive recording layer and other coating layers, such as protective layer and undercoat layer, is not limited in particular, but any known conventional techniques may be used. The method for coating may be appropriately selected from off machine coating machines and on machine coating machines, which are equipped with coaters such as air knife coater, rod blade coater, bent blade coater, bevel blade coater, roll coater, curtain coater and the like.

The coating amounts of the thermosensitive recording layer and other coating layers are not limited in particular, but may be determined according to the required performance and the recording suitability. The typical coating amount (in solid) of the thermosensitive recording layer is ordinarily in the range of from 2 to 12 g/m² and the coating amount of the protective layer is preferably in the range of from 0.5 to 5.0 g/m².

Furthermore, various technologies known in the thermosensitive recording medium field, such as a flattening treatment such as super calendaring and the like can be applied as needed after coating individual coating layers.

### EXAMPLES

The following Examples illustrate the present invention, but the Examples are not intended to limit the scope of the present invention. In the following description, the terms parts and % indicate parts by weight and weight %, respectively.

Each dispersion and coating solution were prepared as follows for the production of a thermosensitive recording medium.

### [Preparation of Each Coating Solution]

Undercoat layer coating solution 1-4 were prepared by dispersing and stirring the following formulation:

### <Undercoat Layer Coating Solution 1>

| | |
|---|---|
| Calcined kaolin (trade name: Ansilex 90 manufactured by | 40.0 parts |
| BASF Ltd.) | |
| Plastic hollow particles (trade name: Nipol MH8108A | 222.2 parts |
| manufactured by Zeon Corporation, hollow percentage | |
| 50%, solid content 27%) | |
| Styrene butadiene copolymer latex (trade name ST5526 | 10.0 parts |
| manufactured by Zeon Corporation, solid content 48%) | |

### <Undercoat Layer Coating Solution 2>

| | |
|---|---|
| Calcined kaolin (Ansilex 90) | 30.0 parts |
| Plastic hollow particles (Nipol MH8108A) | 259.3 parts |
| Styrene butadiene copolymer latex (ST5526) | 10.0 parts |

### <Undercoat Layer Coating Solution 3>

| | |
|---|---|
| Calcined kaolin (Ansilex 90) | 20.0 parts |
| Plastic hollow particles (Nipol MH8108A) | 296.3 parts |
| Styrene butadiene copolymer latex (ST5526) | 10.0 parts |

### <Undercoat Layer Coating Solution 4>

| | |
|---|---|
| Calcined kaolin (Ansilex 90) | 10.0 parts |
| Plastic hollow particles (Nipol MH8108A) | 333.3 parts |
| Styrene butadiene copolymer latex (ST5526) | 10.0 parts |

### <Undercoat Layer Coating Solution 5>

| | |
|---|---|
| Plastic hollow particles (Nipol MH8108A) | 370.0 parts |
| Styrene butadiene copolymer latex (ST5526) | 10.0 parts |

### <Undercoat Layer Coating Solution 6>

| | |
|---|---|
| Calcined kaolin (Ansilex 90) | 60.0 parts |
| Plastic hollow particles (Nipol MH8108A) | 148.1 parts |
| Styrene butadiene copolymer latex (ST5526) | 10.0 parts |

### <Undercoat Layer Coating Solution 7>

| | |
|---|---|
| Calcined kaolin (Ansilex 90) | 50.0 parts |
| Plastic hollow particles (Nipol MH8108A) | 185.1 parts |
| Styrene butadiene copolymer latex (ST5526) | 10.0 parts |
| Water | 50.0 parts |

### <Undercoat Layer Coating Solution 8>

| | |
|---|---|
| Calcined kaolin (Ansilex 90) | 100.0 parts |
| Styrene butadiene copolymer latex (ST5526) | 10.0 parts |
| Water | 50.0 parts |

Color developing agent dispersions (Solutions A1 to A5), a leuco dye dispersion (Solution B) and a sensitizer dispersion (Solution C) with the following formulations were separately wet ground using sand grinders until the average particle sizes were about 0.5 μm, and prepared.

### Color Developing Agent Dispersion (Solution A1)

| | |
|---|---|
| N,N′-di-[3-(p-toluenesulfonyloxy) phenyl] urea (hereinafter | 6.0 parts |
| referred to as “urea compound 1”) | |
| Aqueous solution of completely saponified polyvinyl | 5.0 parts |
| alcohol (Kuraray Co., Ltd., PVA117, solid content: 10%) | |
| Water | 1.5 parts |

### Color Developing Agent Dispersion (Solution A2)

| | | |
|---|---|---|
| Urea compound represented by the formula 9 (Formula 9) (hereinafter referred to as | 6.0 | parts |
| “urea compound 2”) | | |

[Formula 9]

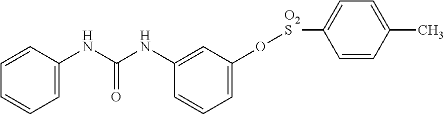 [SMILES: Cc1ccc(S(=O)(=O)Oc2cccc(NC(=O)Nc3ccccc3)c2)cc1]

| | | |
|---|---|---|
| Aqueous solution of completely saponified polyvinyl alcohol (PVA117) | 5.0 | parts |
| Water | 1.5 | parts |

### Color Developing Agent Dispersion (Solution A3)

| | |
|---|---|
| N-[2-(3-phenylureido) phenyl] benzenesulfonamide | 6.0 parts |
| (hereinafter referred to as “urea compound 3”) | |
| Aqueous solution of completely saponified polyvinyl alcohol | 5.0 parts |
| (PVA117) | |
| Water | 1.5 parts |

### Color Developing Agent Dispersion (Solution A4)

Urea urethane-based compound represented by the following general formula

| | | |
|---|---|---|
| (Formula 13) (UU manufactured by Fine Ace) | 6.0 | parts |

[Formula 13]

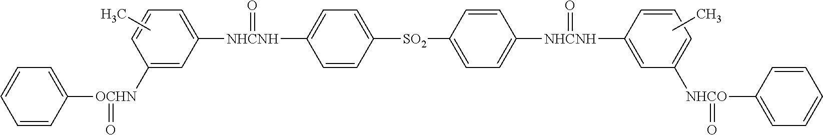

| | | |
|---|---|---|
| Aqueous solution of completely saponified polyvinyl alcohol (PVA117) | 5.0 | parts |
| Water | 1.5 | parts |

### Color Developing Agent Dispersion (Solution A5)

| | |
|---|---|
| 4-hydroxy-4′-isopropoxy diphenyl sulfone (NYDS | 6.0 parts |
| manufactured by Mitsubishi Chemical Corporation) | |
| Aqueous solution of completely saponified polyvinyl alcohol | 5.0 parts |
| (PVA117) | |
| Water | 1.5 parts |

### Leuco Dye Dispersion (Solution B)

| | |
|---|---|
| 3-Dibutylamino-6-methyl-7-anilinofluorane (Yamamoto | 6.0 parts |
| Chemicals Inc., ODB-2) | |
| Aqueous solution of completely saponified polyvinyl | 5.0 parts |
| alcohol (PVA117) | |
| Water | 1.5 parts |

### Sensitizer Dispersion (Solution C)

| | |
|---|---|
| 1,2-bis(2-Methylphenoxy) ethane (Sanko Co. Ltd, KS232) | 6.0 parts |
| Aqueous solution of completely saponified polyvinyl alcohol | 5.0 parts |
| (PVA117) | |
| Water | 1.5 parts |

Next, these dispersions were blended in the proportion described below to prepare the thermosensitive recording layer coating solution.

<Thermosensitive Recording Layer Coating Solution>

| | |
|---|---|
| Color developing agent dispersion (Solution A1) | 36.0 parts |
| Leuco dye dispersion (Solution B) | 18.0 parts |
| Sensitizer dispersion (Solution C) | 5.0 parts |
| Aqueous solution of completely saponified polyvinyl alcohol | 25.0 parts |
| (PVA117) | |

Next, protective layer coating solution was prepared by mixing the following formulations:

### <Protective Layer Coating Solution>

| | |
|---|---|
| Aluminum hydroxide dispersion (trade name: Martifin OL | 9.0 parts |
| manufactured by Martinsberg Limited, solid content 50%) | |
| Carboxy-modified polyvinyl alcohol solution (trade name: | 30.0 parts |
| KL318 manufactured by Kuraray Co., Ltd., degree of | |
| polymerization: about 1800, degree of saponification: | |
| 85 to 90 mol %, solid content 10%) | |
| Poly(amide epichlorohydrin) resin (trade name: WS4030 | 4.0 parts |
| manufactured by Seiko PMC Corporation, solid content | |
| 25%) | |
| Modified polyamine resin (trade name: Sumirez Resin | 2.2 parts |
| SPI-102A manufactured by Taoka Chemical Co., Ltd., | |
| solid content 45%) | |
| Zinc stearate (trade name: Hydrin Z-7-30, manufactured by | 2.0 parts |
| Chukyo Yushi Co., Ltd., solid content 30%) | |

### Example 1

The undercoat layer coating solution was applied on one side of a substrate (groundwood free paper with a basis weight of 47 g/m²) by using a bent blade coater with a coating amount (in solid) of 10.0 g/m², and was dried to prepare an undercoated paper.

The thermosensitive recording layer coating solution was applied on the undercoat layer of the undercoated paper by using a rod blade coater with a coating amount (in solid) of 6.0 g/m² and was dried and super calendared so that the smoothness was 100-500 seconds to prepare a thermosensitive recording medium.

### Example 2

A thermosensitive recording medium was prepared in the same manner as described in Example 1 with the exception of using the undercoat layer coating solution 3 in place of the undercoat layer coating solution 1, changing the amount of Solution A1 in the thermosensitive recording layer coating solution to 18 parts, and adding 18 parts of Solution A4 to the thermosensitive recording layer coating solution.

### Example 3

A thermosensitive recording medium was prepared in the same manner as described in Example 1 with the exception of using the undercoat layer coating solution 3 in place of the undercoat layer coating solution 1, using the Solution A2 in the thermosensitive recording layer coating solution in place of the Solution A1.

### Example 4

A thermosensitive recording medium was prepared in the same manner as described in Example 1 with the exception of using the undercoat layer coating solution 3 in place of the undercoat layer coating solution 1, using the Solution A3 in the thermosensitive recording layer coating solution in place of the Solution A1.

### Example 5

A thermosensitive recording medium was prepared in the same manner as described in Example 1 with the exception of using the undercoat layer coating solution 4 in place of the undercoat layer coating solution 1, changing the amount of Solution A1 in the thermosensitive recording layer coating solution to 18 parts, and adding 18 parts of Solution A2 to the thermosensitive recording layer coating solution.

### Example 6

A thermosensitive recording medium was prepared in the same manner as described in Example 1 with the exception of using the undercoat layer coating solution 2 in place of the undercoat layer coating solution 1, changing the amount of Solution A1 in the thermosensitive recording layer coating solution to 18 parts, and adding 18 parts of Solution A3 to the thermosensitive recording layer coating solution.

### Example 7

A thermosensitive recording medium was prepared in the same manner as described in Example 1 with the exception of using the undercoat layer coating solution 3 in place of the undercoat layer coating solution 1, changing the amount of Solution A1 in the thermosensitive recording layer coating solution to 18 parts, and adding 18 parts of Solution A3 to the thermosensitive recording layer coating solution.

### Example 8

A thermosensitive recording medium was prepared in the same manner as described in Example 1 with the exception of using the undercoat layer coating solution 5 in place of the undercoat layer coating solution 1, changing the amount of Solution A1 in the thermosensitive recording layer coating solution to 18 parts, and adding 18 parts of Solution A3 to the thermosensitive recording layer coating solution.

### Example 9

A thermosensitive recording medium was prepared in the same manner as described in Example 1 with the exception that a protective layer coating solution was applied on the thermosensitive recording layer of the thermosensitive recording layer coated paper by using a rod blade coater with a coating amount (in solid) of 3.0 g/m² and was dried and super calendared so that the smoothness was 100-500 seconds.

### Example 10

A thermosensitive recording medium was prepared in the same manner as described in Example 1 with the exception of using the undercoat layer coating solution 3 in place of the undercoat layer coating solution 1, changing the amount of Solution A1 in the thermosensitive recording layer coating solution to 18 parts, and adding 9 parts of Solution A3 and 9 parts of Solution A4 to the thermosensitive recording layer coating solution.

### Example 11

A thermosensitive recording medium was prepared in the same manner as described in Example 1 with the exception of using the undercoat layer coating solution 3 in place of the undercoat layer coating solution 1, using no Solution A1 in the thermosensitive recording layer coating solution, and adding 18 parts of Solution A2 and 18 parts of Solution A3 to the thermosensitive recording layer coating solution.

### Comparative Example 1

A thermosensitive recording medium was prepared in the same manner as described in Example 1 with the exception of changing the undercoat layer coating solution 1 to the undercoat layer coating solution 6.

### Comparative Example 2

A thermosensitive recording medium was prepared in the same manner as described in Example 3 with the exception that the undercoat layer was not provided.

### Comparative Example 3

A thermosensitive recording medium was prepared in the same manner as described in Example 3 with the exception of changing the undercoat layer coating solution 3 to the undercoat layer coating solution 8.

### Comparative Example 4

A thermosensitive recording medium was prepared in the same manner as described in Example 4 with the exception of changing the undercoat layer coating solution 3 to the undercoat layer coating solution 6.

### Comparative Example 5

A thermosensitive recording medium was prepared in the same manner as described in Example 5 with the exception of changing the undercoat layer coating solution 4 to the undercoat layer coating solution 6.

### Comparative Example 6

A thermosensitive recording medium was prepared in the same manner as described in Example 5 with the exception that the undercoat layer was not provided.

### Comparative Example 7

A thermosensitive recording medium was prepared in the same manner as described in Example 5 with the exception of changing the undercoat layer coating solution 4 to the undercoat layer coating solution 8.

### Comparative Example 8

A thermosensitive recording medium was prepared in the same manner as described in Example 6 with the exception that the undercoat layer was not provided.

### Comparative Example 9

A thermosensitive recording medium was prepared in the same manner as described in Example 6 with the exception of changing the undercoat layer coating solution 2 to the undercoat layer coating solution 8.

### Comparative Example 10

A thermosensitive recording medium was prepared in the same manner as described in Example 11 with the exception that the undercoat layer was not provided.

### Comparative Example 11

A thermosensitive recording medium was prepared in the same manner as described in Example 11 with the exception of changing the undercoat layer coating solution 3 to the undercoat layer coating solution 8.

### Comparative Example 12

A thermosensitive recording medium was prepared in the same manner as described in Example 1 with the exception of using the undercoat layer coating solution 7 in place of the undercoat layer coating solution 1, using no Solution A1 in the thermosensitive recording layer coating solution, and adding 36 parts of Solution A5 to the thermosensitive recording layer coating solution.

### Comparative Example 13

A thermosensitive recording medium was prepared in the same manner as described in Example 1 with the exception of using the undercoat layer coating solution 3 in place of the undercoat layer coating solution 1, using no Solution A1 in the thermosensitive recording layer coating solution, and adding 36 parts of Solution A5 to the thermosensitive recording layer coating solution.

The prepared thermosensitive recording media were evaluated as below.

### <Color Developing Property (Recorded Density)>

A checkerboard pattern was printed on the prepared thermosensitive recording media by using a thermosensitive recording medium print tester (Okura Engineering Co., Ltd. TH-PMD equipped with a thermal head by Kyocera Co.) at applied energy of 0.41 mJ/dot and printing speed of 50 mm/sec. The density of the printed portion was measured by using Macbeth Densitometer (RD-914, with Amber filter) to evaluate the color developing property (recorded density).

### <High-Speed Thermal Printability>

A barcode (CODE39) is printed on the prepared thermosensitive recording media by using a label printer 140XiIII manufactured by Zebra at the printing level of +10 and the printing speed of 30.4 cm/sec (12 inches/sec) in the vertical direction (i.e., so that the moving direction of the printer head and the barcode are orthogonal to each other.) and in the horizontal direction (i.e., so that the moving direction of the printer head and the barcode are parallel to each other.).

Then, the printed barcode is read by a barcode verification machine (Honeywell, QCPC600, light source 640 nm) to evaluate the barcode reading suitability. The evaluation results are shown in the ANSI standard symbol grade.

Symbol grade: The barcode is divided into 10 parts in the direction perpendicular to the bar, and a reading test is performed once at each location, and the average value is represented by a 5-point scale of (excellent) A, B, C, D and F (poor).

### <Heat Resistance in Blank Portion>

The prepared thermosensitive recording medium was left standing for 24 hours under the condition of 80 degree C., and was then allowed to stand for 3 hours under 23 degree C.×50% RH environmental conditions.

The color density of non-printed portion (i.e. blank portion) was measured by using Macbeth Densitometer (RD-914, with Amber filter) and the background color value was calculated from the difference between the color densities before and after the treatment. The heat discoloration resistance in the blank portion was evaluated on the following criteria.

Background color value=(color density of the non printing portion after the treatment)−(color density of the non-printing portion before the treatment)
Good: The background color value is less than 0.3
Fair: The background color value is 0.3 or higher and less than 0.5
Poor: The background color value is 0.5 or higher

### <Plasticizer Resistance>

Checkerboard pattern was printed on the prepared thermosensitive recording media by using a printing tester for thermosensitive recording paper (Okura Engineering Co. LTD., TH-PMD equipped with a thermal head by Kyocera Corporation.) at recording energy of 0.41 mJ/dot and recording speed of 50 mm/sec. A paper tube was wrapped once with polyvinyl chloride wrap (Mitsui Toatsu Chemical: High Wrap KMA) and the thermosensitive recording medium was placed on the wrapped paper tube so that the recorded face is the outer face. Furthermore, the tube was wrapped 3 times with polyvinyl chloride wrap and was left standing for 24 hours under the condition of 23 degree C., 50% RH.

The record density of the recorded section was measured by using Macbeth densitometer (RD-914, with amber filter), and the residual ratio was calculated from the measured value before and after the treatment to evaluate the plasticizer resistance.

Residual ratio (%)=(record density after the treatment/record density before the treatment)×100
Good: The residual rate is 90% or higher
Fair: The residual rate is 70% or higher and less than 90%
Poor: The residual rate is less than 70%

### <Thermal Printing Run-Ability (Prevention of Head Debris)>

Printing of about 10 cm grid was performed on the surface of the prepared thermosensitive recording medium with a label printer from Sato Corporation (Printer name: L'esprit R-8). Head debris stuck to the thermal head after printing was evaluated visually with the following criteria:
Good: Almost no head debris stuck to a thermal head
Fair: Some head debris stuck to a thermal head, but no missing nor blurring of printed images, and no practical problems for use.
Poor: Much sticking of head debris to a thermal head and missing and blurring of printed images observed.

The evaluation results are shown in following Tables.

TABLE 1

| | Exam- | Exam- | Exam- | Exam- | Exam- | Exam- | Exam- | Exam- | Exam- | Exam- | Exam- |
|---|---|---|---|---|---|---|---|---|---|---|---|
| | ple 1 | ple 2 | ple 3 | ple 4 | ple 5 | ple 6 | ple 7 | ple 8 | ple 9 | ple 10 | ple 11 |
| Color developing | urea | urea | — | — | urea | urea | urea | urea | urea | urea | — |
| agent in | com- | com- | | | com- | com- | com- | com- | com- | com- | |
| thermosensitive | pound 1 | pound 1 | | | pound 1 | pound 1 | pound 1 | pound 1 | pound 1 | pound 1 | |
| recording layer | — | — | urea | — | urea | — | — | — | — | — | urea |
| | | | com- | | com- | | | | | | com- |
| | | | pound 2 | | pound 2 | | | | | | pound 2 |
| | — | — | — | urea | — | urea | urea | urea | urea | urea | urea |
| | | | | com- | | com- | com- | com- | com- | com- | com- |
| | | | | pound 3 | | pound 3 | pound 3 | pound 3 | pound 3 | pound 3 | pound 3 |
| | — | UU | — | — | — | — | — | — | — | UU | — |
| | — | — | — | — | — | — | — | — | — | — | — |
| Pigment in | hollow | hollow | hollow | hollow | hollow | hollow | hollow | hollow | hollow | hollow | hollow |
| undercoat layer | particles | particles | particles | particles | particles | particles | particles | particles | particles | particles | particles |
| | Cal- | Cal- | Cal- | Cal- | Cal- | Cal- | Cal- | Cal- | Cal- | Cal- | Cal- |
| | cined | cined | cined | cined | cined | cined | cined | cined | cined | cined | cined |
| | kaolin | kaolin | kaolin | kaolin | kaolin | kaolin | kaolin | kaolin | kaolin | kaolin | kaolin |
| Content of hollow | 60% | 80% | 80% | 80% | 90% | 70% | 80% | 100% | 100% | 80% | 80% |
| particles in | | | | | | | | | | | |
| undercoat layer | | | | | | | | | | | |
| Protective layer | none | none | none | none | none | none | none | none | exist | none | none |
| Color developing | 1.50 | 1.48 | 1.55 | 1.54 | 1.52 | 1.51 | 1.56 | 1.57 | 1.48 | 1.51 | 1.59 |
| property (Recorded | | | | | | | | | | | |
| density) | | | | | | | | | | | |
| High-speed thermal | C2.2 | B2.5 | B2.5 | B2.6 | B2.5 | C2.4 | B2.7 | B2.8 | B2.5 | B2.6 | B2.6 |
| printability | | | | | | | | | | | |
| (Vertical barcode) | | | | | | | | | | | |
| High-speed thermal | B2.6 | B2.6 | B2.7 | B2.8 | B2.6 | B2.7 | B2.8 | B2.9 | B2.6 | B2.9 | B2.9 |
| printability | | | | | | | | | | | |
| (Horizontal barcode) | | | | | | | | | | | |
| Heat resistance | Fair | Fair | Good | Good | Good | Good | Good | Good | Good | Good | Good |
| Plasticizer resistance | Good | Good | Fair | Fair | Good | Good | Good | Good | Good | Good | Good |
| Thermal printing | Good | Fair | Good | Good | Good | Good | Good | Good | Good | Good | Good |
| run-ability | | | | | | | | | | | |

TABLE 2

| | Comp- | Comp- | Comp- | Comp- | Comp- | Comp- | Comp- | Comp- | Comp- | Comp- | Comp- | Comp- | Comp- |
|---|---|---|---|---|---|---|---|---|---|---|---|---|---|
| | Exam- | Exam- | Exam- | Exam- | Exam- | Exam- | Exam- | Exam- | Exam- | Exam- | Exam- | Exam- | Exam- |
| | ple 1 | ple 2 | ple 3 | ple 4 | ple 5 | ple 6 | ple 7 | ple 8 | ple 9 | ple 10 | ple 11 | ple 12 | ple 13 |
| Color developing | urea | — | — | — | urea | urea | urea | urea | urea | — | — | — | — |
| agent in | com- | | | | com- | com- | com- | com- | com- | | | | |
| thermosensitive | pound 1 | | | | pound 1 | pound 1 | pound 1 | pound 1 | pound 1 | | | | |
| recording layer | — | urea | urea | — | urea | urea | urea | — | — | urea | urea | — | — |
| | | com- | com- | | com- | com- | com- | | | com- | com- | | |
| | | pound 2 | pound 2 | | pound 2 | pound 2 | pound 2 | | | pound 2 | pound 2 | | |
| | — | — | — | urea | — | — | — | urea | urea | urea | urea | — | — |
| | | | | com- | | | | com- | com- | com- | com- | | |
| | | | | pound 3 | | | | pound 3 | pound 3 | pound 3 | pound 3 | | |
| | — | — | — | — | — | — | — | — | — | — | — | — | — |
| | — | — | — | — | — | — | — | — | — | — | — | NYDS | NYDS |
| Pigment in | hollow | — | — | hollow | hollow | — | — | — | — | — | — | hollow | hollow |
| undercoat layer | particles | | | particles | particles | | | | | | | particles | particles |
| | Cal- | — | Cal- | Cal- | Cal- | — | Cal- | — | Cal- | — | Cal- | Cal- | Cal- |
| | cined | | cined | cined | cined | | cined | | cined | | cined | cined | cined |
| | kaolin | | kaolin | kaolin | kaolin | | kaolin | | kaolin | | kaolin | kaolin | kaolin |
| Content of hollow | 40% | — | 0% | 40% | 40% | — | 0% | — | 0% | — | 0% | 50% | 80% |
| particles in | | | | | | | | | | | | | |
| undercoat layer | | | | | | | | | | | | | |
| Protective layer | none | none | none | none | none | none | none | none | none | none | none | none | none |
| Color developing | 1.49 | 1.31 | 1.44 | 1.46 | 1.52 | 1.32 | 1.41 | 1.30 | 1.37 | 1.37 | 1.46 | 1.53 | 1.48 |
| property (Recorded | | | | | | | | | | | | | |
| density) | | | | | | | | | | | | | |
| High-speed thermal | F0.4 | unread- | unread- | unread- | F0.3 | unread- | unread- | unread- | unread- | unread- | unread- | C2.4 | B2.6 |
| printability | | able | able | able | | able | able | able | able | able | able | | |
| (Vertical barcode) | | | | | | | | | | | | | |
| High-speed thermal | D1.2 | unread- | F0.4 | D0.6 | D1.3 | unread- | F0.2 | unread- | F0.3 | unread- | D0.5 | B2.6 | B2.8 |
| printability | | able | | | | able | | able | | able | | | |
| (Horizontal barcode) | | | | | | | | | | | | | |
| Heat resistance | Fair | Poor | Fair | Good | Fair | Poor | Fair | Poor | Fair | Poor | Fair | Poor | Poor |
| Plasticizer resistance | Poor | Poor | Poor | Poor | Fair | Poor | Fair | Poor | Fair | Poor | Poor | Fair | Good |
| Thermal printing | Good | Fair | Good | Good | Good | Fair | Good | Fair | Good | Fair | Good | Poor | Poor |
| run-ability | | | | | | | | | | | | | |

1-14. (canceled)

15. A thermosensitive recording medium comprising:
an undercoat layer provided on a substrate; and
a thermosensitive recording layer containing a colorless or pale colored electron donating leuco dye and an electron accepting color developing agent provided on the undercoat layer,
wherein the thermosensitive recording layer contains as the electron accepting color developing agent a urea compound,
wherein the undercoat layer contains 50 to 95 weight % of a pigment by solid and 50 weight % or more of plastic hollow particles by solid with respect to the pigment, and
wherein the urea compound is selected from the group consisting of the following (1) to (3)
(1) a first urea compound represented by the following general formula (Formula 6) 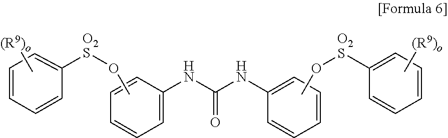
wherein R⁹ may be identical or different from each other and represent an alkyl group having 1 to 4 carbon atoms, and o represents an integer of 0 to 1, and the position of R⁹ in the benzene ring is the 4-position,
(2) a second urea compound represented by the following general formula (Formula 8), and 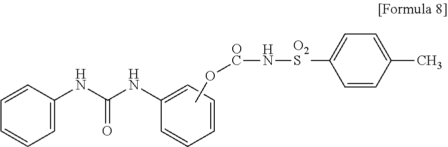
(3) a third urea compound represented as N-[2-(3-phenylureido) phenyl] benzenesulfonamide.

16. The thermosensitive recording medium of claim 15, wherein the thermosensitive recording layer contains at least two kinds of urea compounds selected from the group consisting of the (1) to (3) as the electron accepting color developing agents, provided that two or more kinds are not selected from each of (1), (2) or (3).

17. The thermosensitive recording medium of claim 15, wherein the content, in solid, of the urea compound in the thermosensitive recording layer is from 1.0 to 70.0 weight %.

18. The thermosensitive recording medium of claim 17, wherein the content, in solid, of the first urea compound in the thermosensitive recording layer is from 1.0 to 50.0 weight %, provided that the total content, in solid, of the first to third urea compounds used is within the above-described range.

19. The thermosensitive recording medium of claim 17, wherein the content, in solid, of the second urea compound in the thermosensitive recording layer is from 5.0 to 50.0 weight %, provided that the total content, in solid, of the first to third urea compounds used is within the above-described range.

20. The thermosensitive recording medium of claim 17, wherein the content, in solid, of the third urea compound in the thermosensitive recording layer is from 5.0 to 50.0 weight %, provided that the total content, in solid, of the first to third urea compounds used is within the above-described range.

21. The thermosensitive recording medium of claim 15, wherein the thermosensitive recording layer contains at least one color developing agent other than the first urea compound, the second urea compound and the third urea compound, and the combined amount, in solid, of the first urea compound, the second urea compound and the third urea compound is 90 weight % or more of the total amount of the color developing agents contained in the thermosensitive recording layer.

22. The thermosensitive recording medium of claim 15, wherein each of the plastic hollow particles has a volume hollow percentage of 40 to 95%.
